(19) United States
(12) Patent Application Publication
(10) Pub. No.: US 2011/0140681 A1
(43) Pub. Date: Jun. 16, 2011

(54) DIRECT DC CONVERTER (DC CHOPPER)

(76) Inventor: Andreas Schoenknecht, Stuttgart (DE)

(21) Appl. No.: 12/737,188

(22) PCT Filed: Apr. 28, 2009
(86) PCT No.: PCT/EP2009/055105

§ 371 Date: Feb. 24, 2011

(30) Foreign Application Priority Data
Jun. 19, 2008 (DE) 10 2008 002 525.9

(51) Int. Cl. G05F 3/08

(52) U.S. Cl. 323/311

(57) ABSTRACT

A DC voltage converter has a primary side and a secondary side coupled galvanically to the primary side. The primary side has at least one inductor, and the secondary side has at least two secondary capacitors connected in series. A controllable electronic switching device is situated between the primary side and the secondary side. In a first operating mode, depending on the switching position, the secondary capacitors are charged one after the other via the inductor, and the respective charging process ends approximately at the zero crossing of the respective charging current.

### BACKGROUND OF THE INVENTION

1. Field of the Invention

The present invention relates to a DC-DC converter having a primary side and a secondary side that is coupled galvanically to the primary side.

2. Description of Related Art

To supply electric machines of hybrid drives, high voltage batteries or traction batteries are used, to which an inverter is postconnected. A nominal voltage of high voltage batteries is approximately 100 V-300 V. Based on the battery's internal resistance, a voltage at an intermediate circuit of the inverter, depending on the operating type, as a motor or as a generator, of the electric machine, and depending on the transmitted electric power, amounts to between ca. 50 V and 400 V. A high intermediate voltage leads to cost savings and space savings in the inverter, in wiring harnesses used in the motor vehicle and in the electric machine. In order to achieve these, a single-phase or multi-phase boost chopper is used for increasing the voltage. The classical boost chopper has an inductor which generates an intermittently increased voltage, together with a capacitor, a diode and using a switch. The disadvantage of using such a boost chopper in a hybrid drive is that a very high induction value of the inductor is required, which leads to high costs and to the requirement of a large installation space. Furthermore, semiconductors are used as switches which, during switching, bring about current step changes, which leads to high electrical losses and, with that, to a large required semiconductor surface, which also requires corresponding installation space and generates high costs. In addition, the current step changes lead to a high electromagnetic load in the environment.

### BRIEF SUMMARY OF THE INVENTION

It is therefore an object of the present invention to bring about the increase in a DC voltage in a cost-effective manner, and while saving installation space.

The object is attained, according to the present invention, in that the primary side has at least one inductor and the secondary side has at least two secondary capacitors connected in series, a controllable or regulatable electronic switching device being situated between the primary side and the secondary side, which in a first operating mode, depending on the switching position, charges the secondary capacitors one after the other via the inductor, and ends the respective charging process approximately at the zero crossing of the respective charging current. In the first operating mode, a DC voltage present on the primary side is increased using the DC voltage converter, and is output on the secondary side. In this context, it is especially provided that the primary side is assigned to a high voltage battery and the secondary side is assigned to an electric machine. The electric machine is preferably a drive assembly of a hybrid drive. Then a motor drive comes about for the first operating mode. Because of the ending of the respective charging process, approximately at the zero crossing of the respective charging current, it is prevented that the switching device generates current step changes upon switching. This, in turn leads to only slight losses being created on the switching device. In addition, based on the procedure according to the present invention, for preventing current step changes from occurring during switching by switching at zero crossings, the electromagnetic load on the environment is considerably reduced. For a durable DC voltage increase, the secondary capacitors are loaded and unloaded in a cyclical manner.

According to one advantageous refinement of the present invention, it is provided that the inductor and the switching rate of the switching device are dimensioned in such a way that the respective charging current has an approximately sinusoidal half-wave curve. In order to achieve this, a resonant behavior of the inductor within the DC voltage converter is of advantage. Based on the design of the inductor having resonance, only a very slight inductance value of the inductor is required, and the inductor may therefore be designed to be very small. The switching rate gives the frequency of switching of at least one switching element. If the charging current has an approximately sinusoidal half-wave curve, it follows that there is a zero crossing of the charging current at each switching.

According to one refinement of the present invention, it is provided that the primary side has two input terminals to which a primary capacitor is connected. The use of an additional primary capacitor leads to the primary capacitor, being charged first in a DC voltage conversion. Subsequently, the secondary capacitors are charged using the voltage stored in the primary capacitor, via the inductor and the switching device, whereby the DC voltage conversion is able to be generated very effectively and cyclically.

According to one refinement of the present invention, two inductors are provided, the one inductor being connected to the one input terminal and to the switching device, and the other inductor being connected to the other input terminal and to the switching device. The two inductors make possible a symmetrization of the circuit structure of the DC voltage converter. Furthermore, its simultaneous action as a filter for electromagnetic compatibility is of advantage.

According to one advantageous refinement of the present invention, it is provided that the switching device has electronic power semiconductors as switching elements. Because of the switching at zero crossings of the charging current, when semiconductors are used in the switching device, only a small semiconductor surface is required, whereby costs and installation space of the DC voltage converter may also be saved.

According to one refinement of the present invention, it is provided that diodes are connected in parallel to the switching elements. The use of the diodes in parallel to the switching elements leads to the switching elements being able to develop their interrupted action only in one current flow direction. Consequently, it is possible to maintain the current flow in one direction, via the diode, for instance, from the secondary side to the primary side at one place, whereas the reverse direction is only able to be used if necessary by closing the switching element.

According to one refinement of the present invention, it is provided that at least two switching elements are connected in series while developing a connecting point, and to that connecting point one of the inductors being connected to the series connection of one of the secondary capacitors. The use of a plurality of switching elements at one connecting point leads to different circuit paths being able to have current applied to them within the DC voltage converter. If, in addition to the switching elements, diodes are used that are connected in parallel to them, it is possible to establish a circuit direction by switching the switching elements. A circuit then closes using a switch, via one of the diodes as well as the inductor.

In one advantageous refinement of the present invention, it is provided that the switching device, in a second operating mode, charges the primary capacitor via the at least one inductor, using a successive discharge of the secondary capacitors, the respective charging current being switched off by the switching device approximately at a zero crossing. The second operating mode leads to the charging current being led from the secondary side to the primary side. In the process, the DC voltage present at the secondary side is correspondingly lowered going towards the primary side. This second operating mode is particularly advantageous if the DC voltage converter is to be used optionally as a step-up converter, that is, for increasing the DC voltage present at the primary side, or as a step-down converter, that is, for decreasing the direct voltage present at the secondary side. This may be used when the high voltage battery is connected to the primary side and the electric machine is connected to the secondary side. In the first operating mode, in the operation as motor, the high voltage battery applies current to the electric machine, whereby the latter functions as an electric drive. In the second operating mode, the electric machine applies current to the high voltage battery, whereby the latter is loaded, which is denoted as operation as a generator.

On the secondary side of the DC voltage converter, the potential is shifted at the switching rate of the switching device with respect to the potential on the primary side. From this it comes about that an intermediate circuit voltage supply at an inverter that is postconnected to the secondary circuit has to be set up free of potential.

### BRIEF DESCRIPTION OF THE DRAWINGS

FIG. 1 shows a circuit diagram of a DC voltage converter.

FIG. 2 shows a charging current at a first secondary capacitor in a first operating mode.

FIG. 3 shows a charging current at a second secondary capacitor in a first operating mode.

### DETAILED DESCRIPTION OF THE INVENTION

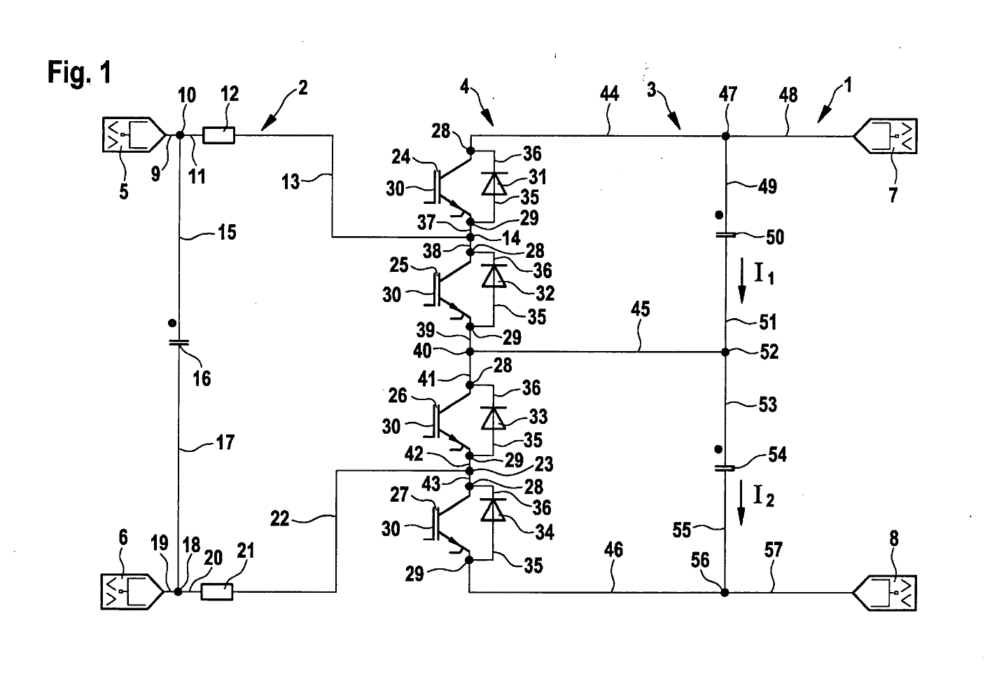

FIG. 1 shows a DC voltage converter 1 as a circuit diagram. DC voltage converter 1 has a primary side 2 and a secondary side 3, between which a switching device 4 is situated. DC voltage converter 1 has two input terminals 5 and 6, which connect a high voltage battery, that is not shown, to primary side 2, whereby a primary voltage is present at the terminals. On secondary side 3 an inverter, that is not shown, which is preconnected to an electric machine of the hybrid drive of a motor vehicle, is connected via two output terminals 7 and 8, at which a secondary voltage is present. Starting from input terminal 5, a line 9 runs to a node 10. From node 10, a line 11 runs to an inductor 12, which is connected to a connecting point 14, using a line 13. Starting from node 10, an additional line 15 runs to a primary capacitor 16, which is connected to a node 18 via a second line 17. Node 18 leads to input terminal 6 via line 19. Via a third line 20, node 18 is connected to an inductor 21, which is connected to connecting point 23 using a line 22. Connecting points 14 and 23 are the connecting points 14 and 23 of primary side 2 to switching device 4. Switching device 4 has four switching elements 24, 25, 26 and 27. Each of switching elements 24, 25, 26 and 27 has an input node 28 and an output node 29. Switching elements 24, 25, 26 and 27 are developed as power semiconductors 30, in this context. Each of power semiconductors 30 has a flow-through direction that goes from its input node 28 to its output node 29. Diodes 31, 32, 33 and 34 are assigned to switching elements 24, 25, 26 and 27. Diodes 31, 32, 33 and 34 are each connected via a line 35 to output node 29 and via a line 36 to input node 29 of switching element 24, 25, 26 and 27 that is assigned to them. Diodes 31, 32, 33 and 34 have a flow-through direction that runs counter to the flow-through direction of power semiconductor 30 assigned to them. Connecting point 14 is connected to output node 29 of switching element 24 via a line 37. Furthermore, connecting point 14 is connected to input node 28 of switching element 25 via a line 38. At output node 29 of switching element 25, a line 39 is connected which goes to a node 40, from which a line 41 goes to input node 28 of switching element 26. Output node 29 of switching element 26 is connected via a line 42 to connecting point 23, which is connected by a line 43 to input node 28 of switching element 27. Secondary side 3 is connected by a line 44 to input node 28 of switching element 24, by a line 45 to node 40 and by a line 46 to output node 29 of switching element 27. Line 44 leads to a node 47, which is connected to output terminal 7 via a line 48. From node 47, an additional line 49 leads to a first secondary capacitor 50, which is connected to a node 52 via a line 51. Node 52 is also connected to line 45, and has another, third line 53, which leads to a second secondary capacitor 54. A line 55 connects secondary capacitor 54 to a node 56, which is connected to line 46 and an additional line 57. Line 57 connects node 56 to output terminal 8.

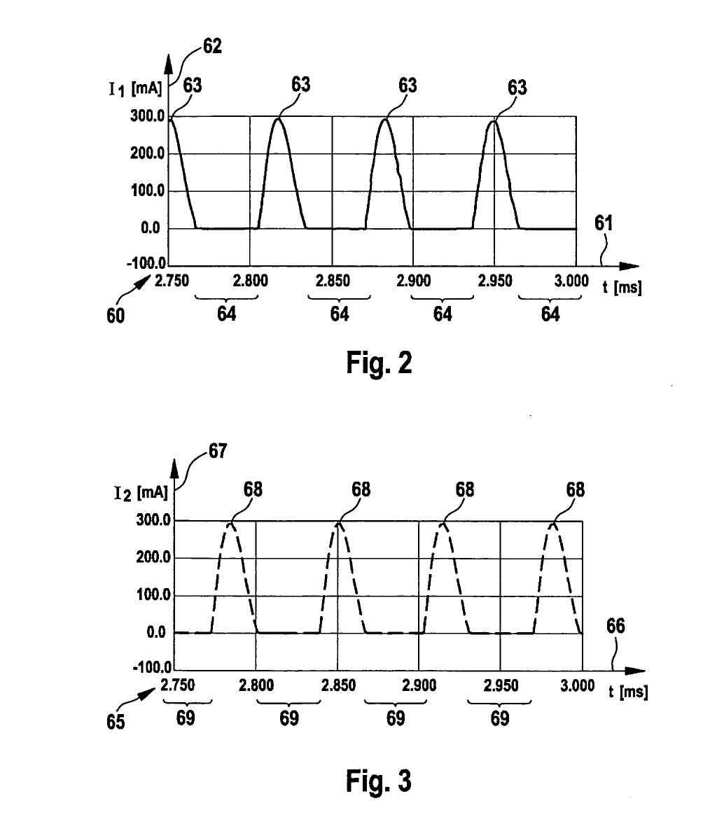

FIG. 2 shows a Cartesion coordinate system 60 having an abscissa 61, that is associated with time t, and an ordinate 62, that is associated with a charging current I₁, which is present at secondary capacitor 50. Four sinusoidal half-wave curves 63 are situated within the Cartesion coordinate system. Between the half-wave curves 63, time spans 64 are present, in which charging current I₁ is equal to zero.

FIG. 3 shows a Cartesion coordinate system 65 having an abscissa 66, that is associated with time t, and an ordinate 67, that is associated with a charging current I₂, which is present at secondary capacitor 54. Sinusoidal half-wave curves 68 are shown within coordinate system 65. Between the sinusoidal half-wave curves 68, time spans 69 are present, in which charging current I₂ is equal to zero.

The sinusoidal half-wave curves 63 and 68 in FIGS. 2 and 3 are offset in time with respect to each other in such a way that half-wave curves 68 lie within time spans 64 and half-wave curves 63 lie within time spans 69.

DC voltage converter 1 shown in FIG. 1 raises the primary voltage applied between input terminals 5 and 6 by a fixed factor. This factor is preferably the factor of 2, other factors such as factors of 3, 4 and 5 also being conceivable. For those, however, changes would be required in the design of DC voltage converter 1. At output terminals 7 and 8 a correspondingly raised secondary voltage is emitted. The raising of the primary voltage to the secondary voltage represents a first operating mode, which is used to increase the DC voltage of the high voltage battery and then make it available to the inverter of the electric machine, which is why the first operating mode is designated as the operation as a motor. In addition, a second operating mode using the DC voltage converter 1 shown, in which the secondary voltage is supplied and reduced to the primary voltage. This is used to charge the high voltage battery using the electric machine, which is why this second operating mode is designated as operation as a generator.

In operation as a motor, electric power is transmitted from the high voltage battery to the electric machine. In the process, the electric charge is transmitted from primary capacitor 16 to secondary capacitors 50 and 54 in two steps. In the first step first secondary capacitor 50 is first charged. In this case, switching element 26 is closed and switching elements 24, 25 and 27 are open. Secondary capacitor 50 is then charged by primary capacitor 16 via diode 31, switching element 26 and inductors 12 and 21. The inductances of inductors 12 and 21 are adjusted resonantly to the entire electrical system in such a way that charging current I₁ at first secondary capacitor 50 has positive sinusoidal half-wave curve 63. When charging current I₁ reaches the value zero, switching element 26 is opened, at no, or hardly any current step change. In the second step the charging of secondary capacitor 54 takes place. For this purpose, switching element 25 is closed and switching elements 24, 26 and 27 remain open. Secondary capacitor 54 is then charged by primary capacitor 16 via switching element 25, diode 34 and inductors 12 and 21. Because of the resonant design of the inductances of inductors 12 and 21, the positive sinusoidal half-wave curve 68 comes about for charging current I₂. When charging current I₂ reaches the value zero, switching element 25 is opened, without a current step change taking place in the process. In this way, the operation as a motor is able to be generated durably by a cyclical, alternating switching of switching elements 26 and 25.

In operation as a generator, power is transmitted from the electric machine to the high voltage battery. In this context, electric charge is transmitted by secondary capacitors 50 and 54 to primary capacitor 16 in two steps. In the first step there is a charge transmission from first secondary capacitor 50 to primary capacitor 16. For this purpose, switching element 24 is first closed and switching elements 25, 26 and 27 are maintained in the opened state. Primary capacitor 16 is then charged by secondary capacitor 50 via diode 33, switching element 24 and inductors 12 and 21. Based on the resonant design of the inductances of inductors 12 and 21, there comes about in this charging of primary capacitor 16 charging current I₁ having negative sinusoidal half-wave curves that are not shown. When charging current I₁ reaches the value zero, switching element 24 is opened, without generating a current step change. In the second step, the electric charge is transmitted by second capacitor 54 to primary capacitor 16. For this purpose, switching element 27 is first closed and switching elements 24, 25 and 26 are maintained open. Primary capacitor 16 is then charged by secondary capacitor 54 via switching element 27, diode 32 and inductors 12 and 21. Based on the resonant design of the inductances of inductors 12 and 21, it turns out that charging current I₂ has negative sinusoidal half-wave curves, that are not shown. When charging current I₂ reaches the value zero, switching elements 27 is opened in the advantageous manner shown. Consequently, it turns out that charging currents I₁ and I₂ assume from operation as a generator the curve of charging currents I₁ and 1₂ from operation as a motor, but having a negative sign.

In the DC voltage converter 1 provided, what is critical is particularly sudden voltage changes between a potential of the high voltage battery and the potential of a postconnected inverter intermediate circuit, which is preconnected to the electric machine. This comes about since, especially, the difference of the potentials during switching on a power semiconductors 30 changes suddenly. This sudden change in the potential difference leads to high frequency harmonics in the voltage curve of DC voltage converter 1. These high frequency harmonics are able to lead to critical compensation currents via a capacitively coupled ground. To counter that, these compensating currents are able to be advantageously designed by suitable grounding concepts within the hybrid drive device. Moreover, it is conceivable that one may use time spans, in which all the switching elements 24, 25, 26 and 27 are open, for a pre-charge reversal of the voltage potentials.

The electromagnetic load additionally created by the shifting of the potentials is in contrast to a topology-conditioned filtering, and, with that, a reduction in high frequency interference on the traction network side caused by an inverter operation.

1-8. (canceled)

9. A DC voltage converter, comprising:
a primary side having at least one inductor;
a secondary side coupled galvanically to the primary side, wherein the secondary side has at least two secondary capacitors connected in series; and
a selectively controllable electronic switching device situated between the primary side and the secondary side, wherein in a first operating mode, depending on a switching position of the switching device, the secondary capacitors are charged one after the other via the inductor, and the respective charging process is ended approximately at the zero crossing of the respective charging current.

10. The DC voltage converter as recited in claim 9, wherein the inductor and a switching rate of the switching device are configured so that the respective charging current has an approximately sinusoidal half-wave curve.

11. The DC voltage converter as recited in claim 10, wherein the primary side has two input terminals, and a primary capacitor is connected to the two input terminals.

12. The DC voltage converter as recited in claim 10, wherein the primary side has two inductors, one inductor being connected to one input terminal and the switching device, and the other inductor being connected to the other input terminal and the switching device.

13. The DC voltage converter as recited in claim 12, wherein the switching device has electronic power semiconductors as switching elements.

14. The DC voltage converter as recited in claim 13, further comprising:
diodes connected in parallel to the switching elements.

15. The DC voltage converter as recited in claim 13, wherein at least two switching elements are connected in series while forming a connecting point, one of the inductors being connected to the connecting point and one of the secondary capacitors being connected to the series connection.

16. The DC voltage converter as recited in claim 11, wherein the switching device in a second operating mode charges the primary capacitor via the at least one inductor using successive discharge of the secondary capacitors, the respective charging current being switched off by the switching device approximately at the respective zero crossing.
